(19) United States
(12) Patent Application Publication
(10) Pub. No.: US 2025/0287860 A1
(43) Pub. Date: Sep. 18, 2025

(54) AGRICULTURAL SYSTEMS AND METHODS

(71) Applicant: CNH Industrial America LLC, New Holland, PA (US)

(72) Inventors: Brittany Schroeder, Bunker Hill, IN (US); Devon Olson, Barnesville, MN (US); Aaron Franzen, Omaha, NE (US)

(21) Appl. No.: 18/602,491

(22) Filed: Mar. 12, 2024

(51) Int. Cl. A01B 79/00; A01B 76/00

(52) U.S. Cl. CPC A01B 79/005; A01B 76/00

(57) ABSTRACT

An agricultural system can include an implement including a frame assembly. One or more ground-engaging tools can be operably supported by the frame assembly. The agricultural system can further include a vehicle including a power plant. A computing system can be operably coupled with the vehicle. An implement control unit can be communicatively coupled to the computing system and the sensor system. The implement control unit can include a processor and associated memory. The memory can store instructions that, when implemented by the processor, configure the implement control unit to receive a power band and a torque curve(s) of the power plant from the computing system, determine a defined operating speed for operating the implement based at least in part on the power band and torque curve(s) of the power plant, and transfer a speed instruction to the vehicle to operate the vehicle at the defined operating speed.

### FIELD OF THE INVENTION

The present subject matter relates generally to tillage implements that may be operated within an agricultural field.

### BACKGROUND OF THE INVENTION

In some cases, to increase agricultural performance from a field, a farmer may cultivate the soil, typically through a tillage operation. For instance, tillage operations may be performed by pulling a tillage implement behind an agricultural vehicle, such as a tractor. Tillage implements can include one or more ground-engaging tools configured to engage the soil as the implement is moved across the ground. For example, in certain configurations, the implement may include one or more harrow disks, leveling disks, rolling baskets, shanks, tines, and/or the like. Such ground-engaging tool(s) loosen and/or otherwise agitate the soil to prepare the ground for subsequent planting operations.

In some instances, to conduct the operations correctly and efficiently, a vehicle speed may need to be matched to the operating conditions of the implement, which can be potentially difficult if the operating conditions are changed. Accordingly, an improved system and method for performing agricultural operations with an implement would be welcomed in the technology.

### BRIEF DESCRIPTION OF THE INVENTION

Aspects and advantages of the technology will be set forth in part in the following description, or may be obvious from the description, or may be learned through practice of the technology.

In some aspects, the present subject matter is directed to an agricultural system that includes an implement including a frame assembly. One or more ground-engaging tools is operably supported by the frame assembly. A vehicle includes a power plant. A computing system is operably coupled with the vehicle. An implement control unit is communicatively coupled to the computing system. The implement control unit includes a processor and associated memory. The memory stores instructions that, when implemented by the processor, configure the implement control unit to receive a power band and a torque curve of the power plant from the computing system, determine a defined operating speed for operating the implement based at least in part on the power band and the torque curve of the power plant, and transfer a speed instruction to the vehicle to operate the vehicle at the defined operating speed.

In some aspects, the present subject matter is directed to a method for operating an agricultural system. The method includes receiving, from a computing system, a power band and a torque curve of a power plant from the computing system. The method also includes determining, with a control unit communicatively coupled with the computing system, a defined operating speed for operating an implement based at least in part on the power band and the torque curve of the power plant. Lastly, the method includes transferring a speed instruction from the control unit to a vehicle to operate the vehicle at the defined operating speed.

In some aspects, the present subject matter is directed to an agricultural system including an implement including a frame assembly. One or more ground-engaging tools is operably supported by the frame assembly. A vehicle includes a power plant. An implement control unit includes a processor and associated memory. The memory stores instructions that, when implemented by the processor, configure the implement control unit to determine a defined operating speed for operating the implement based at least in part on a power band and a torque curve of the power plant.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a front perspective view of an agricultural machine in accordance with aspects of the present subject matter;

FIG. 2 illustrates a front perspective view of an agricultural implement in accordance with aspects of the present subject matter;

FIG. 3 illustrates a block diagram of components of a system for an agricultural machine in accordance with aspects of the present subject matter; and

FIG. 4 illustrates a flow diagram of a method for operating an agricultural system in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield still a further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based at least partially on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to agricultural systems and methods for an agricultural system that can include an implement having a frame assembly. One or more ground-engaging tools can be operably supported by the frame assembly. The agricultural system can further include a vehicle including a power plant. A computing system can be operably coupled with the vehicle.

An implement control unit can be communicatively coupled to the computing system and the sensor system. The implement control unit can include a processor and associated memory. The memory can store instructions that, when implemented by the processor, configure the implement control unit to receive a power band and a torque curve of the power plant from the computing system, determine a defined operating speed for operating the implement based at least in part on the power band and torque curve of the power plant, and transfer a speed instruction to the vehicle to operate the vehicle at the defined operating speed. The defined operating speed may be configured to match a predefined setting, which may be a high-efficiency mode, a maximum speed mode, a maximum work by the ground engaging tools mode, and/or any other mode.

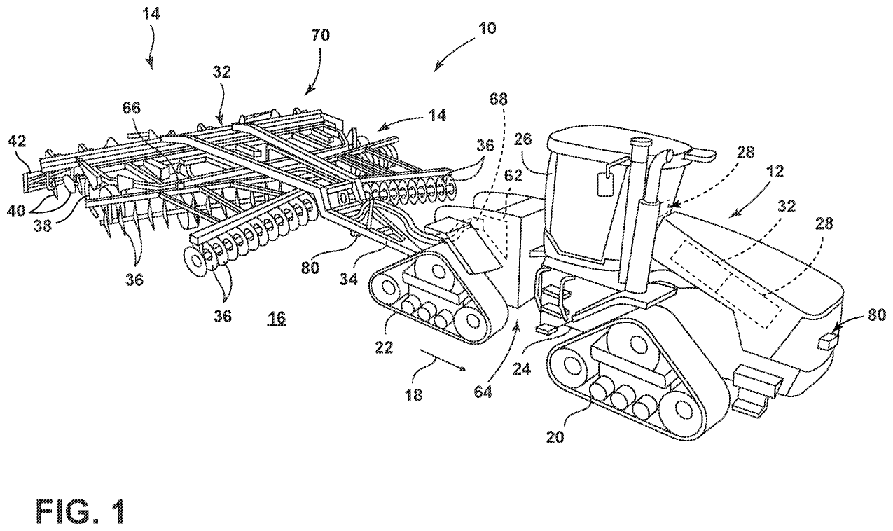

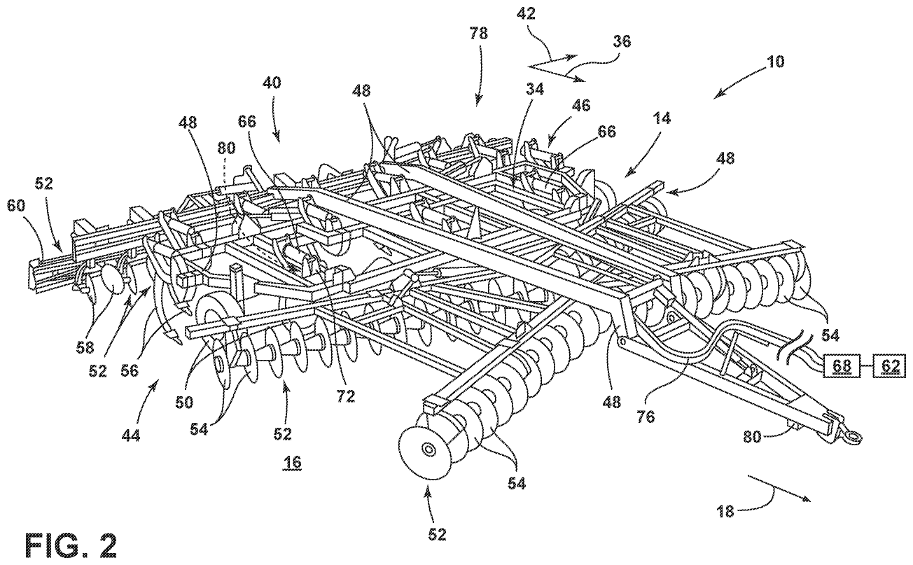

Referring now to drawings, FIGS. 1 and 2 illustrate an agricultural machine 10 that can include a vehicle 12 and an associated agricultural implement 14. In general, the vehicle 12 is configured to tow the implement 14 across the ground 16 in a direction of travel (e.g., as indicated by arrow 18 in FIG. 1). In the illustrated examples, the vehicle 12 is configured as an agricultural tractor, and the implement 14 is configured as an associated tillage implement. However, in other embodiments, the vehicle 12 may be configured as any other suitable type of vehicle, such as an agricultural harvester, a self-propelled sprayer, and/or the like. Similarly, the implement 14 may be configured as any other suitable type of implement, such as a planter. Furthermore, the agricultural machine 10 may correspond to any suitable powered and/or unpowered agricultural machine 10 (including suitable vehicles and/or equipment, such as only a vehicle or only an implement). Additionally, the agricultural machine 10 may include two or more associated vehicles, implements, and/or the like (e.g., a tractor, a planter, and an associated air cart).

As shown in FIG. 1, the vehicle 12 includes a pair of front track assemblies 20, a pair of rear track assemblies 22, and a frame or chassis 24 coupled to and supported by the track assemblies 20, 22. An operator's cab 26 may be supported by a portion of the chassis 24 and may house various input devices 28 for permitting an operator to control the operation of one or more components of the vehicle 12 and/or one or more components of the implement 14. However, the input devices 28 may be located in any other suitable location. The input devices 28 may be configured to provide feedback to the operator of the agricultural machine 10. Thus, the input devices 28 may include one or more feedback devices, such as display screens, speakers, warning lights, and/or the like, which are configured to communicate such feedback. In addition, some examples of the input devices 28 may include one or more touchscreens, keypads, touchpads, knobs, buttons, sliders, switches, mice, microphones, and/or the like, which are configured to receive user inputs from the operator.

Additionally, the vehicle 12 may include a power source 30 and a transmission 32 mounted on the chassis 24. The transmission 32 may be operably coupled to the power source 30 and may provide variably adjusted gear ratios for transferring power to the track assemblies 20, 22 via a drive axle assembly (or via axles if multiple drive axles are employed).

Additionally, as shown in FIG. 2, the implement 14 may generally include a frame assembly 34 configured to be towed by the vehicle 12 via a pull hitch or tow bar in the direction of travel 18 of the vehicle 12. The frame assembly 34 may extend along a longitudinal direction 36 between a forward end portion 38 and an aft end portion 40. The frame assembly 34 may also extend along a lateral direction 42 (FIG. 2) between a first side portion 44 and a second side portion 46. In this respect, the frame assembly 34 generally includes a plurality of structural frame members 48, such as beams, bars, and/or the like, configured to support or couple to a plurality of components. Additionally, a plurality of wheel assemblies 50 may be coupled to the frame assembly 34 to facilitate towing the implement 14 in the direction of travel 18.

The frame assembly 34 may be configured to support a plurality of ground-engaging tools 52, such as a plurality of shanks, disk blades, levelers (e.g., leveling blades), basket assemblies, tines, spikes, and/or the like. For example, the frame assembly 34 may be configured to support various gangs of disk blades 54, a plurality of ground-engaging shanks 56, a plurality of levelers 58 (e.g., leveling blades), and a plurality of crumbler wheels or basket assemblies 60. However, in alternative embodiments, the frame assembly 34 may be configured to support any other suitable ground-engaging tools 52 and/or a combination of ground-engaging tools 52. In several embodiments, the various ground-engaging tools 52 may be configured to perform a tillage operation or any other suitable ground-engaging operation across the ground 16 along which the implement 14 is being towed. It should be understood that, in addition to being towed by the vehicle 12, the implement 14 may also be a semi-mounted implement connected to the vehicle 12 via a two-point hitch or the implement 14 may be a fully mounted implement (e.g., mounted to the vehicle's three-point hitch).

The configuration of the agricultural machine 10 described above and shown in FIGS. 1 and 2 is provided only to place the present subject matter in an example field of use. Thus, the present subject matter may be readily adaptable to any manner of machine configurations, including any suitable vehicle configuration and/or implement configuration. For example, in an alternative example of the vehicle 12, a separate frame or chassis may be provided to which the power source 30, transmission, and drive axle assembly are coupled, a configuration common in smaller vehicles. Still other configurations may use an articulated chassis to steer the vehicle 12 or rely on tires/wheels in lieu of the track assemblies 20, 22. Similarly, as indicated above, the frame assembly 34 of the implement 14 may be configured to support any other suitable combination of type of ground-engaging tools 52.

Referring further to FIGS. 1 and 2, in some examples, the vehicle 12 can also include auxiliary systems 62 coupled to the power source 30. For example, one such auxiliary system 62 can be a hydraulic system 64 (FIG. 1) which provides a source of pressurized hydraulic fluid for powering various actuators 66 used for driving and/or positioning implements 14 and other detachable equipment. For instance, the vehicle 12 can include a hydraulically-powered three-point hitch and/or one or more electro-hydraulic remote (EHR) valves 68 for controlling the flow of hydraulic fluid to actuators 66 located remotely from the vehicle 12, such as those used by an implement positioning assembly 70.

In some cases, a height adjustment and thereby depth of engagement for the implement 14 can be controlled by the implement positioning assembly 70 for raising and lowering the frame assembly 34 with respect to the nominal surface of the ground 16. In various examples, the plurality of wheel assemblies 50 may be coupled to a link assembly 72. The link assembly 72 can be pivotally coupled to the frame assembly 34 to allow for movement of the plurality of wheel assemblies 50 relative to the frame when the hydraulic actuator 66 is actuated. In various instances, the movement of the hydraulic actuator 66 is controlled by the EHR valve 68, which is connected to hydraulic actuator 66 by hoses 76.

The EHR valve 68 can receive selective input from the one or more input devices 28, a control system 78, and/or any other source. When the actuator 66 extends, the actuator 66 can move one or more links 74 of the link assembly 72 causing one or more wheels of the plurality of wheel assemblies 50 to lower downward toward the frame assembly 34. Since the plurality of wheel assemblies 50 may be resting on the ground 16 when the actuator 66 is extended and/or retracted, the wheel does not actually “rise” or “fall.” Instead, the frame assembly 34 rises or falls with respect to the plurality of wheel assemblies 50, and hence with respect to the ground 16. Thus, whenever-the hydraulic actuator 66 extends, the frame assembly 34 rises upwardly away from the ground 16 and whenever the hydraulic actuator 66 retracts, the frame assembly 34 lowers downward towards the ground 16, or vice versa. Using the frame assembly 34 as a reference point, however, one can say that the wheels are “raised” or “lowered.” Additionally or alternatively, the implement positioning assembly 70 may include one or more wheels of the plurality of wheel assemblies 50, links within the link assembly 72, and/or the hydraulic actuator 66 for vertically altering the implement position.

Whenever the frame assembly 34 is raised or lowered with respect to the ground 16, the depth of penetration of the ground-engaging tools 52 may also be increased or decreased. Thus, whenever the ground-engaging tools 52 extend further toward, or into, the ground 16 or the ground-engaging tools 52 move further from, or out of, the ground 16, a tractive effort or draft force required of the vehicle 12 to pull the implement 14 through the ground 16 is altered. Ground injector tools may impose additional requirements in that the ground injector tools may have minimum ground engagement limits during injection activities.

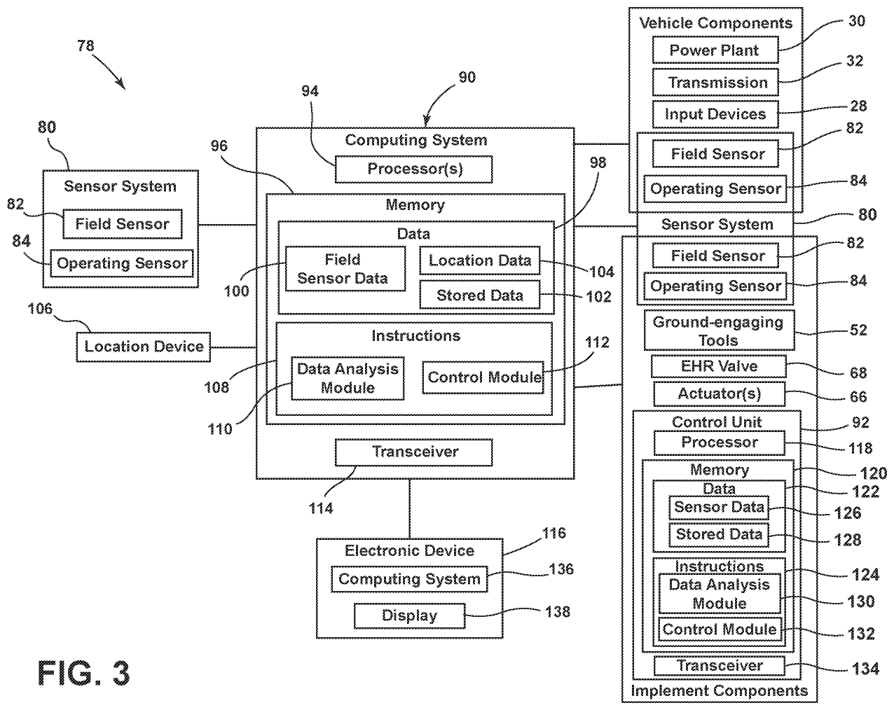

Furthermore, in accordance with aspects of the present subject matter, the agricultural machine 10 may include a sensor system 80 for capturing data related to the ground 16 and/or the agricultural machine 10. In some instances, the sensor system 80 can include one or more field sensors 82 (FIG. 3) coupled thereto and/or supported by the agricultural machine 10. Each field sensor 82 (FIG. 3) may, for example, be configured to capture data indicative of one or more conditions of the ground 16 along which the machine 10 is being traversed. For example, in several examples, the field sensor 82 (FIG. 3) may be used to collect data associated with one or more conditions of the ground 16, such as residue size, size distribution of the residue (the number or amount of residue that falls into each size category), and/or any other suitable condition that affects the performance of the implement 14.

In general, the one or more field sensors 82 (FIG. 3) may correspond to any suitable devices or other assembly configured to capture images. For instance, in several examples, the one or more field sensors 82 (FIG. 3) may correspond to a camera assembly. In such examples, the camera assembly may be used to capture images of the ground 16 and/or an area proximate thereto. In various examples, the camera assembly may include a pair of lenses and a pair of image sensors for capturing two-dimensional images. Additionally, by simultaneously capturing an image of the same portion of the ground 16 with each image sensor, the separate images can be combined, compared, and/or otherwise processed to extract three-dimensional information about such a portion of the ground 16. For example, by comparing the images captured by each camera, a depth image can be generated that allows the scene depth to be determined (e.g., relative to the camera) at each corresponding pixel location within the imaged portion of the ground 16. As a result, the relative depth of specific features or points within the ground 16 may be determined. In addition to a camera assembly or as an alternative thereto, the agricultural machine 10 may include any other suitable type of field sensor 82 (FIG. 3). In several examples, the field sensor 82 (FIG. 3) may additionally or alternatively correspond to a radio detection and ranging (RADAR) sensor, an ultrasonic sensor, a Light Detection and Ranging (LIDAR) sensor, a sound navigation and ranging (SONAR) sensor, any other vision-based sensor, and/or any other practicable sensor.

Additionally or alternatively, the sensor system 80 can include the one or more operating sensors 84 (FIG. 3) that may be configured to capture data indicative of one or more operating conditions or parameters associated with the performance and/or operation of the machine 10. In various examples, the operating sensors 84 may include position sensors, flow sensors, motion sensors (e.g., accelerometers, gyroscopes, etc.), image sensors (e.g., cameras, LIDAR devices, etc.), radar sensors, ultrasonic sensors, and/or any other practicable sensor, depending on the operating conditions being monitored.

Referring now to FIG. 3, a schematic view of the control system 78 for an agricultural machine 10 is illustrated in accordance with aspects of the present subject matter. In several examples, the disclosed system 78 is configured to determine a defined operating speed for operating the implement 14 based at least in part on a power band and a torque curve of the power plant. In some cases, the system 78 is further configured to compare a current power usage of the total vehicle power to a defined power threshold and determine the defined operating speed based at least in part on the current power usage of the total vehicle power. The system 78 will generally be described herein with reference to the agricultural machine 10 described above with reference to FIGS. 1 and 2. However, the disclosed system 78 may generally be utilized with agricultural machines having any other suitable machine configuration.

As shown in FIG. 3, the system 78 may include the sensor system 80, which can include the one or more field sensors 82 configured to capture data indicative of various conditions of a region of the ground 16 and/or the one or more operating sensors 84 (FIG. 3) that may be configured to capture data indicative of one or more operating conditions or parameters associated with the performance and/or operation of the machine 10.

With further reference to FIG. 3, the system 78 can include a computing system 90 communicatively coupled to a control unit 92 and/or the sensor system 80. In general, the computing system 90 may include any suitable processor-based device, such as a computing device or any suitable combination of computing devices. Thus, in several examples, the computing system 90 may include one or more processors 94 and associated memory 96 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 96 of the computing system 90 may generally comprise memory element(s) including, but not limited to, a computer-readable medium (e.g., random access memory (RAM)), a computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 96 may generally be configured to store suitable computer-readable instructions that, when implemented by the processors 94, configure the computing system 90 to perform various computer-implemented functions, such as one or more aspects of the data processing algorithm(s) and/or related method(s) described below. In addition, the computing system 90 may also include various other suitable components, such as a communications circuit or module, one or more input/output channels, a data/control bus, and/or the like.

In several examples, the computing system 90 may correspond to an existing controller of the agricultural machine 10, or the computing system 90 may correspond to one or more separate processing devices. For instance, in some examples, the computing system 90 may form all or part of a separate plug-in module or computing device(s) that is installed relative to the vehicle 12 or implement 14 to allow for the disclosed system 78 and method to be implemented without requiring additional software to be uploaded onto existing control devices of the vehicle 12 or the implement 14.

In several examples, the memory 96 of the computing system 90 may include one or more databases 98 for storing information received from any source. For instance, as shown in FIG. 3, the memory 96 may include a sensor database 100 storing data associated with the data captured by the sensor system 80. Additionally, the memory 96 may include a stored data database 102 storing data acquired from various sources. For instance, the stored data can include a field map that is generated through any method, such as with a previous agricultural operation, user-entered information, from the sensor system 80, and/or other systems.

Additionally or alternatively, as shown in FIG. 3, the memory 96 may also include a location database 104, which may be configured to store location data generated by a location device 106 that is stored in association with the data for later use in geo-locating the data relative to the ground 16. In some examples, the location device 106 may be configured as a satellite navigation positioning device (e.g. a GPS, a Galileo positioning system, a Global Navigation satellite system (GLONASS), a BeiDou Satellite Navigation and Positioning system, a dead reckoning device, and/or the like) to determine the location of the machine 10.

Moreover, as shown in FIG. 3, in several examples, the memory 96 may also include instructions 108 that may be executed by the processor 94 to implement a data analysis module 110. In general, the data analysis module 110 may be configured to process/analyze the sensor data, the stored data, the location data, and/or any other data.

In some examples, the instructions 108 stored within the memory 96 of the computing system 90 may also be executed by the processor 94 to implement a control module 112. In general, the control module 112 may be configured to electronically control the operation of one or more components of the agricultural machine 10 and/or generate one or more transfers of data/information to another component of the system 78 through a transceiver 114. For instance, one or more communicative links or interfaces (e.g., one or more data buses) may be provided between the transceiver 114 and the input devices 28, a control unit 92 operably coupled with the implement 14, an electronic device 116, and/or any other device.

In some examples, the control unit 92 is operably coupled with the implement 14. The control unit 92 is configured to output commands to one or more components of the implement 14, receive commands and/or information from a computing system 90, which may be remote from the implement 14, receive data from one or more components of the implement 14, transfer data to any other component, and/or perform any other function. For example, the control unit 92 may receive an attached vehicle's power band, torque curve, and/or any other information. In turn, the implement 14 may use the received power band and torque curve to determine an operating speed for the implement 14 to operate at a predefined setting, which may be a high-efficiency mode, a maximum speed mode, a maximum work by the ground-engaging tools mode, and/or any other mode.

In various examples, the control unit 92 may be configured as an electronic controller having electrical circuitry configured to process data. In the illustrated example, the control unit 92 includes a processor, such as the illustrated microprocessor 118, and a memory 120. The processor 118 may be used to execute software, such as software for determining an operating speed, a defined position of one or more implement components, and so forth. Moreover, the processor 118 may include multiple microprocessors, one or more “general-purpose” microprocessors, one or more special-purpose microprocessors, and/or one or more application-specific integrated circuits (ASICS), or some combination thereof. For example, the processor 118 may include one or more reduced instruction set (RISC) processors. The memory 120 may include a volatile memory, such as RAM, and/or a nonvolatile memory, such as ROM. The memory 120 may store a variety of data 122 and/or processor-executable instructions 124 (e.g., firmware or software) for the processor 118 to execute.

In several examples, the memory 120 of the control unit 92 may include one or more databases 122 for storing information received and/or generated by the control unit 92, the computing system 90, the sensor system 80, and/or any other component. For instance, as shown in FIG. 3, the memory 120 may include a sensor database 126 storing data associated with the data captured by the sensor system 80. Additionally, the memory 120 may include a stored data database 128 storing data acquired from various sources, such as the computing system 90 and/or various lookup tables (LUTs) that may include information related to the implement 14 and/or components of the implement 14.

Moreover, as shown in FIG. 3, in several examples, the memory 120 may also include instructions 124 that may be executed by the processor 118 to implement a data analysis module 130. In general, the data analysis module 130 may be configured to process/analyze the captured data received from the sensor system 80 and the stored data. In various examples, the data analysis module 130 may be configured to execute one or more data processing algorithms or functions to determine a defined implement speed.

Referring still to FIG. 3, in some examples, the instructions 108 stored within the memory 120 of the computing system 90 may also be executed by the processor 118 to implement a control module 132. In general, the control module 132 may be configured to electronically control the operation of one or more components of the implement 14 and/or generate instructions/information that is provided to the computing system 90 and/or any other component. For instance, in several examples, the control module 132 may be configured to control the operation of the agricultural implement 14. Such control may include altering a position of the frame assembly 34 (e.g., a pitch and/or a roll of the frame assembly 34), which in turn can alter a portion of one or more of the ground-engaging tools 52 of the implement 14 (e.g., the disk blades 54, shanks 56, levelers 58 (e.g., leveling blades), and/or basket assemblies 60) to proactively or reactively adjust the operation of the implement 14 in view of the monitored condition(s). Additionally or alternatively, the control module may generate data, information, and/or instructions that may be provided to the computing system 90, which, in turn, may be used to control a component of the vehicle 12. In some cases, the control unit 92 may provide instructions to the component of the vehicle 12 directly in addition to or alternatively to providing the instructions to the computing system 90.

In the illustrated example, the control unit 92 further includes a transceiver 134 to allow for the control unit 92 to communicate with various components that may be remote from the implement 14. For instance, one or more communicative links or interfaces (e.g., one or more data buses) may be provided between the transceiver 134 and a computing system 90, an input device, an electronic device 116, and/or any other device.

The electronic device 116 may include a variety of computing systems 136 including a processor and memory and/or a display 138 for displaying information to a user. For instance, the electronic device 116 may display one or more user interfaces and may be capable of receiving remote user input. In addition, the electronic device 116 may provide feedback information, such as visual, audible, and tactile alerts, and/or allow the operator to alter or adjust one or more components of the agricultural machine 10 through the usage of the remote electronic device 116. For example, the electronic device 116 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

Although the various control functions and/or actions will generally be described herein as being executed by the computing system 90 and/or the control unit 92, one or more of such control functions/actions (or portions thereof) may be executed by a separate computing system, may be distributed across two or more computing systems (including, for example, the computing system 90 and a separate computing system), the computing system and the control unit 92, and/or separate computing system, may be distributed across two or more computing systems (including, for example, the computing system 90 and a separate computing system).

With further reference to FIG. 3, in some cases, upon start-up of the machine 10 and/or providing power to the control unit 92, the computing system 90 may transmit the vehicle's power band and torque curve(s) to the control unit 92. The power band may be defined as the range of operating speeds under which the power plant can output the most power, that is, the maximum energy per unit of time. In addition, the torque curve(s) may be defined as a range of torque produced across different power plant operational conditions. In turn, the control unit 92 can use the power band and torque curve(s) to determine an operating speed for operating the implement 14 at a predefined setting, which may be a high-efficiency mode, a maximum speed mode, a maximum work by the ground-engaging tools mode, and/or any other mode.

For example, in some cases, the control unit 92 may receive the vehicle's power band and torque curve(s) as well as a set of current operational parameters, which may be received from the computing system 90, the sensor system 80, and/or any other component. In turn, the control unit 92 may implement an operating speed function to determine an operating speed by using the power band, the torque curve, the current power requirement, and the current operational parameters to determine if the implement speed can be increased or decreased. In some cases, the control unit 92 may determine a current power usage of the vehicle 12 and compare the current power usage of the total vehicle power to a defined power threshold (e.g., 95% power usage of the total power available). If the current power usage is at or above the defined power threshold, the control unit 92 may maintain a current speed due to not wanting to exceed the power available by the vehicle 12. As used herein, the current speed may be a speed at which the vehicle 12 is currently moving.

In some cases, the vehicle speed may be varied (e.g., reduced) based on whether slip or any other condition is detected to provide better traction of the vehicle 12. For example, the system 78 may receive slip data indicative of a wheel slippage condition and, in turn, set the defined operating speed below the current speed when a wheel slippage condition is detected.

If the current power usage is less than the defined power threshold, the control unit 92 may then determine the current position of the one or more ground-engaging tools 52 (e.g., a depth and basket pressures of the ground-engaging tools 52), the current speed of the implement 14, and a draft force function that is indicative of a resulting draft force for each change in the position of the one or more ground-engaging tools 52 and the implement speed, which may be stored in the memory of the control unit 92, to assess a calculated power usage for the implement 14 to operate at the defined operating speed. In turn, the control unit 92 may determine a calculated power usage for the current speed.

In several examples, the control unit 92 may also determine a calibration value that defines a difference between the calculated power usage and the current power values. The control unit 92 may then use the calculated maximum power, the calibration factor, and/or the implement's operational parameters to calculate an updated operating speed for the implement 14 and the vehicle 12.

If the defined operating speed is varied from the current speed, the control unit 92 may compare the defined operating speed to an implement speed limit to ensure that the implement 14 does not exceed the defined operating speed limit of the implement 14. If the defined operating speed is greater than the speed limit of the implement 14, the defined operating speed may be set to the implement speed limit. The defined operating speed may then be transferred to the vehicle 12 to be implemented either with or without operator intervention. The control system 78 may use the data provided by the sensor system 80, the computing system 90, and the control unit 92 to provide any number of operating speeds at a defined interval, intermittent periods, any time a change in the vehicle 12 operating parameters and/or field conditions is detected, and/or at any other frequency.

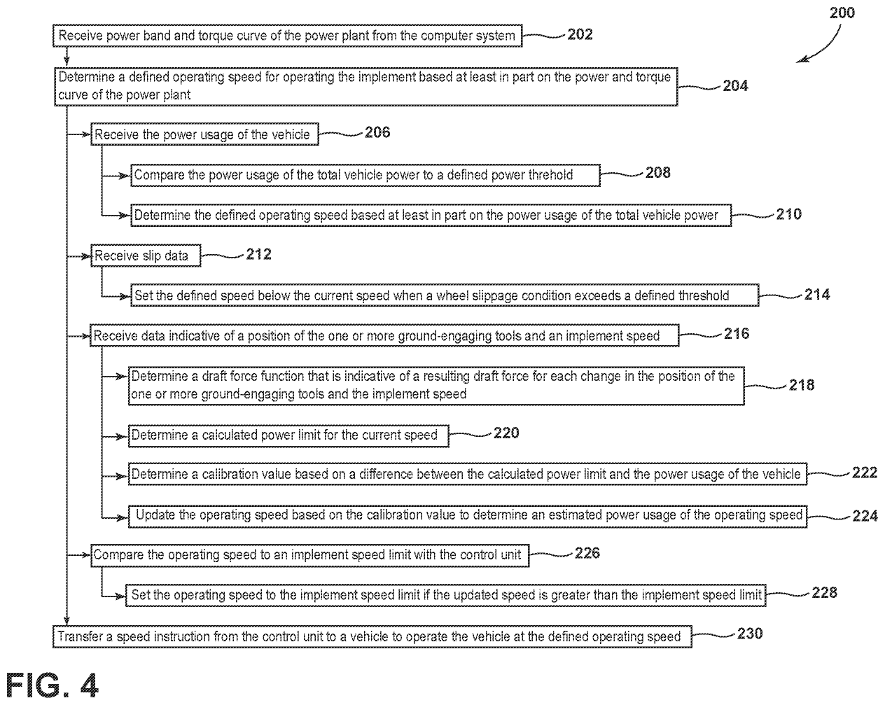

Referring now to FIG. 4, a flow diagram of a method 200 for operating an agricultural system is illustrated in accordance with aspects of the present subject matter. In general, the method 200 will be described herein with reference to the agricultural machine 10 shown in FIGS. 1 and 2 and the various system components shown in FIGS. 3 and 4. However, it will be appreciated that the disclosed method 200 may be implemented with agricultural machines having any other suitable machine configurations and/or within systems having any other suitable system configuration without deviating from the present disclosure. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As illustrated, at (202), the method 200 can include receiving the power band and torque curve(s) of the power plant from the computing system. The power band and torque curve(s) of the vehicle may be provided by the computing system of the vehicle and/or input by an operator of the system.

At (204), the method 200 can include determining a defined operating speed for operating the implement based at least in part on the power band and torque curve(s) of the power plant with a control unit communicatively coupled with the computing system.

In some examples, at (206), determining a defined operating speed can further include receiving the current power usage of the vehicle from the computing system and/or from any other source. At (208), the method 200 can include comparing the current power usage of the total vehicle power to a defined power threshold with the control unit, the computing system, and/or any other component of the system. At (210), the method 200 can include determining the defined operating speed based at least in part on the current power usage of the total vehicle power with the control unit, the computing system, and/or any other component of the system.

In various examples, at (212), determining a defined operating speed can further include receiving slip data from the sensor system, the computing system, the control unit, and/or any other source. At (214), the method can include setting the defined operating speed below the current speed when a wheel slippage condition exceeds a defined threshold, which may be detected with the control unit, the computing system, and/or any other component of the system. In various examples, the defined threshold may be preset based on the machine configuration, user input(s), operating conditions, and/or based on any other input or information. For instance, the defined threshold may be equal to a defined traction that may be obtained at a specific slip percentage, which for large, four-wheel drive tractors, may be six percent wheel slip.

In some examples, at (216), determining a defined operating speed can further include receiving data indicative of a position of the one or more ground-engaging tools and an implement speed from the computing system and/or any other component of the system. At (218), the method 200 can include determining a draft force function that is indicative of a resulting draft force for each change in the position of the one or more ground-engaging tools and the implement speed with the control unit, the computing system, and/or any other component of the system. At (220), the method can include determining a calculated power usage for the current speed with the control unit, the computing system, and/or any other component of the system. At (222), the method can include determining a calibration value based on a difference between the calculated power usage and the current power usage of the vehicle with the control unit, the computing system, and/or any other component of the system. At (224), the method 200 can include updating the defined operating speed based on the calibration value to determine an estimated power usage of the defined operating speed with the control unit, the computing system, and/or any other component of the system.

In some examples, at (226), determining a defined operating speed can further include comparing the defined operating speed to an implement speed limit with the control unit, the computing system, and/or any other component of the system. At (228), the method 200 can include setting the defined operating speed to the implement speed limit if the defined operating speed is greater than the implement speed limit.

At (230), the method 200 can include transferring a speed instruction from the control unit to a vehicle to operate the vehicle at the defined operating speed. The defined operating speed may then be sent to the vehicle to be implemented either with or without operator intervention.

In various examples, the method 200 may implement machine learning methods and algorithms that utilize one or several machine learning techniques including, for example, decision tree learning, including, for example, random forest or conditional inference trees methods, neural networks, support vector vehicles, clustering, and Bayesian networks. These algorithms can include computer-executable code that can be retrieved by the computing system and/or through a network/cloud and may be used to evaluate and update the defined operating speed. In some instances, the machine learning engine may allow for changes to the defined operating speed to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the computing system, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural system comprising:
an implement including a frame assembly;
one or more ground-engaging tools operably supported by the frame assembly;
a vehicle including a power plant;
a computing system operably coupled with the vehicle; and
an implement control unit communicatively coupled to the computing system, the implement control unit including a processor and associated memory, the memory storing instructions that, when implemented by the processor, configure the implement control unit to:
receive a power band and a torque curve of the power plant from the computing system;
determine a defined operating speed for operating the implement based at least in part on the power band and the torque curve of the power plant; and
transfer a speed instruction to the vehicle to operate the vehicle at the defined operating speed.

2. The agricultural system of claim 1, further comprising:
a sensor system operably coupled with the implement.

3. The agricultural system of claim 2, wherein the sensor system is further operably coupled with the vehicle.

4. The agricultural system of claim 3, wherein the sensor system is configured to generate data indicative of one or more operating parameters.

5. The agricultural system of claim 4, wherein the one or more operating parameters includes a current power usage of the vehicle.

6. The agricultural system of claim 5, wherein the control unit is further configured to:
receive the current power usage of the vehicle;
compare the current power usage of a total vehicle power to a defined power threshold; and
determine the defined operating speed based at least in part on the current power usage of the total vehicle power.

7. The agricultural system of claim 6, wherein the control unit is further configured to set the defined operating speed at a current speed when a current power is at or above the defined power threshold.

8. The agricultural system of claim 5, wherein the one or more operating parameters includes slip data indicative of a wheel slippage condition, and wherein the control unit is further configured to:
receive the slip data; and
set the defined operating speed below a current speed when a wheel slippage condition exceeds a defined threshold.

9. The agricultural system of claim 5, wherein the control unit is further configured to:
receive data indicative of a position of the one or more ground-engaging tools and an implement speed;
determine a draft force function that is indicative of a resulting draft force for each change in the position of the one or more ground-engaging tools and the implement speed; and
determine a calculated power usage for a current speed.

10. The agricultural system of claim 9, wherein the control unit is further configured to:
determine a calibration value based on a difference between the calculated power usage and the current power usage of the vehicle.

11. The agricultural system of claim 10, wherein the control unit is further configured to:
update the defined operating speed based on the calibration value to determine an estimated power usage of the defined operating speed.

12. The agricultural system of claim 10, wherein the control unit is further configured to:
compare the defined operating speed to an implement speed limit; and
set the defined operating speed to the implement speed limit if the defined operating speed is greater than the implement speed limit.

13. A method for operating an agricultural system, the method comprising:
receiving, from a computing system, a power band and a torque curve of a power plant from the computing system;
determining, with a control unit communicatively coupled with the computing system, a defined operating speed for operating an implement based at least in part on the power band and the torque curve of the power plant; and
transferring a speed instruction from the control unit to a vehicle to operate the vehicle at the defined operating speed.

14. The method of claim 13, further comprising:
receiving, from the computing system, a current power usage of the vehicle;
comparing, with the control unit, the current power usage of a total vehicle power to a defined power threshold; and
determining, with the control unit, the defined operating speed based at least in part on the current power usage of the total vehicle power.

15. The method of claim 13, further comprising:
receiving, from the computing system, slip data; and
setting, with the control unit, the defined operating speed below a current speed when a wheel slippage condition exceeds a defined threshold.

16. The method of claim 13, further comprising:
receiving, from the computing system, data indicative of a position of one or more ground-engaging tools and an implement speed;
determining, with the control unit, a draft force function that is indicative of a resulting draft force for each change in the position of the one or more ground-engaging tools and the implement speed; and
determining, with the control unit, a calculated power usage for a current speed.

17. The method of claim 16, further comprising:
determining, with the control unit, a calibration value based on a difference between the calculated power usage and the current power usage of the vehicle; and
updating, with the control unit, the defined operating speed based on the calibration value to determine an estimated power usage of the defined operating speed.

18. The method of claim 13, further comprising:
comparing, with the control unit, the defined operating speed to an implement speed limit; and
setting, with the control unit, the defined operating speed to the implement speed limit if the defined operating speed is greater than the implement speed limit.

19. An agricultural system comprising:
an implement including a frame assembly;
one or more ground-engaging tools operably supported by the frame assembly;
a vehicle including a power plant; and
an implement control unit including a processor and associated memory, the memory storing instructions that, when implemented by the processor, configure the implement control unit to:
determine a defined operating speed for operating the implement based at least in part on a power band and a torque curve of the power plant.

20. The agricultural system of claim 19, wherein the control unit is further configured to:
compare a current power usage of a total vehicle power to a defined power threshold; and
determine the defined operating speed based at least in part on the current power usage of the total vehicle power.
